(19) United States
(12) Patent Application Publication
(10) Pub. No.: US 2026/0150057 A1
(43) Pub. Date: May 28, 2026

(54) TERMINAL, BASE STATION, AND COMMUNICATION SYSTEM

(71) Applicant: 1FINITY Inc., Kawasaki-shi (JP)

(72) Inventors: Huiting Cheng, Yokohama (JP); Tsuyoshi Shimomura, Yokohama (JP)

(73) Assignee: 1FINITY Inc., Kawasaki-shi (JP)

(21) Appl. No.: 19/444,334

(22) Filed: Jan. 9, 2026

Related U.S. Application Data
(63) Continuation of application No. PCT/JP2023/029037, filed on Aug. 9, 2023.

(51) Int. Cl. H04W 52/14; H04B 7/06; H04W 24/10

(52) U.S. Cl. CPC H04W 52/143; H04B 7/0626; H04W 24/10

(57) ABSTRACT

A terminal includes: a receiver configured to receive third information related to transmission power and fourth information related to transmission power; a controller configured to generate measurement information for each of a plurality of sub-configurations for measurement in accordance with the third information and the fourth information; and a transmitter configured to transmit the measurement information, wherein the controller estimates second information related to reception power of a third signal corresponding to each of the plurality of sub-configurations for measurement according to first information related to reception power of a second signal received by the receiver, the third information, and the fourth information, and generates the measurement information.

### CROSS-REFERENCE TO RELATED APPLICATION

This application is a continuation application of International Application PCT/JP 2023/029037 filed on Aug. 9, 2023 and designated the U.S., the entire contents of which are incorporated herein by reference.

### FIELD

The present embodiment relates to a terminal, a base station, and a communication system.

### BACKGROUND

In current networks, the traffic of mobile terminals (a smartphone or a feature phone) occupies most of resources of the network. In addition, the traffic used by mobile terminals is expected to continue to grow in the future.

Furthermore, in addition to the traffic used by mobile terminals, for example, Internet of a Things (IoT) services (for example, a monitoring system of a traffic system, a smart meter, a device, or the like) are being deployed. Therefore, networks are demanded to cope with services having various requirements. In order to cope with such various services, in communication standards (for example, Non Patent Documents 11 to 25) of the fifth generation of mobile communication (5G or New Radio (NR)), for example, in addition to the standard technology (for example, Non Patent Documents 1 to 10) of the fourth generation mobile communication (4G), standards have been developed assuming support of many use cases classified into enhanced mobile broadband (eMBB), massive machine type communications (MTC), and ultra-reliable and low latency communications (URLLC).

In the international standardization project called the 3rd Generation Partnership Project (3GPP®), extension technologies of the above communication standards are still being continuously studied and standardized.

In the 3rd Generation Partnership Project (3GPP), technologies for Network Energy Savings (NES) are being studied to reduce power consumption on the network side (that is, in base station devices and core network equipment) (see Non Patent Document 28).

One of the technologies related to NES is a technology concerning Spatial Domain (SD) adaptation, which is being studied. In addition, as a technology related to spatial domain adaptation, it has been agreed that multiple patterns associated with antenna ports are configured for one resource for measurement (see Non Patent Document 29). In addition, it has also been agreed that a sub-configuration for measurement is set for each antenna port pattern (see Non Patent Document 29).

For example, related arts are disclosed in, 3GPP TS 36.133 V 17.10.0 (Non Patent Document 1), 3GPP TS 36.211 V 17.3.0 (Non Patent Document 2), 3GPP TS 36.212 V 17.1.0 (Non Patent Document 3), 3GPP TS 36.213 V 17.5.0 (Non Patent Document 4), 3GPP TS 36.214 V 17.0.0 (Non Patent Document 5), 3GPP TS 36.300 V 17.4.0 (Non Patent Document 6), 3GPP TS 36.321 V 17.5.0 (Non Patent Document 7), 3GPP TS 36.322 V 17.0.0 (Non Patent Document 8), 3GPP TS 36.323 V 17.2.0 (Non Patent Document 9), 3GPP TS 36.331 V 17.4.0 (Non Patent Document 10), 3GPP TS 37.324 V 17.0.0 (Non Patent Document 11), 3GPP TS 37.340 V 17.5.0 (Non Patent Document 12), 3GPP TS 38.133 V 17.10.0 (Non Patent Document 13), 3GPP TS 38.201 V 17.0.0 (Non Patent Document 14), 3GPP TS 38.202 V 17.3.0 (Non Patent Document 15), 3GPP TS 38.211 V 17.5.0 (Non Patent Document 16), 3GPP TS 38.212 V 17.5.0 (Non Patent Document 17), 3GPP TS 38.213 V 17.6.0 (Non Patent Document 18), 3GPP TS 38.214 V 17.6.0 (Non Patent Document 19), 3GPP TS 38.215 V 17.3.0 (Non Patent Document 20), 3GPP TS 38.300 V 17.5.0 (Non Patent Document 21), 3GPP TS 38.321 V 17.5.0 (Non Patent Document 22), 3GPP TS 38.322 V 17.3.0 (Non Patent Document 23), 3GPP TS 38.323 V 17.5.0 (Non Patent Document 24), 3GPP TS 38.331 V 17.5.0 (Non Patent Document 25), 3GPP TS 38.420 V 17.2.0 (Non Patent Document 26), 3GPP TS 38.423 V 17.5.0 (Non Patent Document 27), 3GPP TR 38.864 V 18.0.0 (Non Patent Document 28), and R1-2306262 (Non Patent Document 29).

### SUMMARY

According to an aspect of the embodiment, a terminal including: a receiver configured to receive third information related to transmission power and fourth information related to transmission power; a controller configured to generate measurement information for each of a plurality of sub-configurations for measurement in accordance with the third information and the fourth information; and a transmitter configured to transmit the measurement information. The controller estimates second information related to reception power of a third signal corresponding to each of the plurality of sub-configurations for measurement according to first information related to reception power of a second signal received by the receiver, the third information, and the fourth information, and generates the measurement information.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a wireless communication system according to a first embodiment;

FIG. 2 is an example of a functional block configuration diagram of a base station in the wireless communication system of the first embodiment;

FIG. 3 is an example of a functional block configuration diagram of a terminal in the wireless communication system of the first embodiment;

FIG. 4 is a diagram illustrating an example of a CSI-RS resource in a resource block;

FIGS. 5A to 5C are diagrams illustrating an example of an antenna port pattern;

FIG. 6 is a diagram illustrating an example of a sequence of the wireless communication system in the first embodiment;

FIG. 7 is a diagram illustrating an example of a processing flow of a terminal according to the first embodiment;

FIGS. 8A to 8C are diagrams illustrating an example of a relationship between an EPRE of a second signal received by a terminal, an EPRE of a third signal received by the terminal, and information related to transmission power;

FIG. 9 is a diagram illustrating an example in which the processing of the example of the first embodiment is reflected in the specification (TS38.214);

FIG. 10 is a diagram illustrating a first example in which the processing of the example of a second embodiment is reflected in the specification (TS38.214);

FIG. 11 is a diagram illustrating a second example in which the processing of the example of the second embodiment is reflected in the specification (TS38.214);

FIG. 12 is an example of a hardware configuration diagram of the base station in the wireless communication system; and

FIG. 13 is an example of a hardware configuration diagram of the terminal in the wireless communication system.

### DESCRIPTION OF EMBODIMENTS

In a case of attempting to achieve network energy saving using spatial domain adaptation, merely setting multiple parameters related to antenna ports may result in improper reporting of information.

Specifically, when a terminal device transmits information corresponding to measurement information to a base station device, there are cases where information corresponding to the measurement information is notified in consideration of the transmission power of a signal transmitted from the base station device. For example, in a case where a channel state information (CSI) reference resource is set such that a channel quality information (CQI) index is reported as information corresponding to the measurement information, the terminal needs to derive and transmit the CQI index by taking into account the ratio between the energy per resource element (EPRE) of the measured Channel state information-reference signal (CSI-RS) and the EPRE of the physical downlink shared channel (PDSCH) transmitted from the base station device. In this case, in a case where the EPRE of the PDSCH is not estimated for each parameter related to the antenna port, the reporting information is not performed properly.

Therefore, in order to perform spatial domain adaptation, for example, a method of estimating the status of the signal transmitted from the base station according to the setting of the antenna port is needed.

Hereinafter, the present embodiment will be described in detail with reference to the drawings. Problems and embodiments in the present specification are merely examples, and do not limit the scope of rights of the present application. In particular, the technology of the present application can be applied to even different expressions as long as the expressions are technically equivalent even if the expressions are different, and the scope of rights is not limited. Each embodiment can be appropriately combined within a range in which the process contents do not contradict each other.

In addition, terms and technical contents described in the present specification may be appropriately used as terms and technical contents described in a specification or a contribution as a communication standard such as 3GPP. Such specifications are described in Non Patent Documents 1 to 29, for example.

Hereinafter, embodiments of a base station, a terminal, and a wireless communication system disclosed in the present application will be described in detail with reference to the drawings. Note that the following embodiments do not limit the disclosed technology.

### FIRST EMBODIMENT

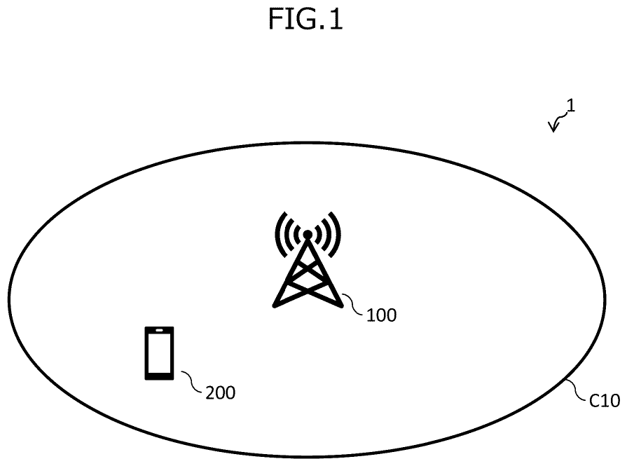

FIG. 1 is a diagram illustrating an example of a wireless communication system 1 according to a first embodiment. The wireless communication system 1 includes a base station 100 and a terminal 200. Note that the base station 100 forms a cell C10. In addition, the terminal 200 exists in the cell C10.

Note that the base station 100 may be, for example, a small radio base station (including a micro radio base station, a femto radio base station, and the like) such as a macro radio base station, a pico radio base station, and other wireless base stations of various scales, and may be described in terms of a base station apparatus, a wireless communication apparatus, a communication apparatus, a transmission apparatus, and the like. Furthermore, the terminal 300 may be, for example, a wireless terminal such as various devices and apparatuses (sensor devices and the like) having a wireless communication function, such as a mobile phone, a smartphone, a personal digital assistant (PDA), a personal computer, and a vehicle, and may be paraphrased as a terminal apparatus, a wireless communication apparatus, a communication apparatus, a reception apparatus, a mobile station, and the like.

The base station 100 is connected to a network via a wired connection with a network device (an upper-level device or another base station) (not illustrated). Note that the base station 100 may be connected to the network device wirelessly instead of the wired manner.

The base station 100 may separate the wireless communication function with the terminal 200 from the digital signal processing and control function to form a separate device. In this case, a device having a wireless communication function can be referred to as a Remote Radio Head (RRH), and a device having a digital signal processing and control function can be referred to as a Base Band Unit (BBU). In addition, the RRHs may be installed to protrude from the BBU, and each of the RRHs and the BBU may be connected to each other in a wired manner with an optical fiber or the like. Alternatively, they may be connected in a wireless manner. Further, for example, it may be separated into a Central Unit (CU), a Distributed Unit (DU), and a Radio Unit (RU) instead of the RRHs and the BBUs described above. The DU includes, for example, a function of a Media Access Control (MAC) layer. In addition, the DU may include, for example, a function of a Radio Link Control (RLC) layer. The RU includes at least an RF radio circuit. The DU and the RU may be integrated.

On the other hand, the terminal 200 communicates with the base station 100 by wireless communication.

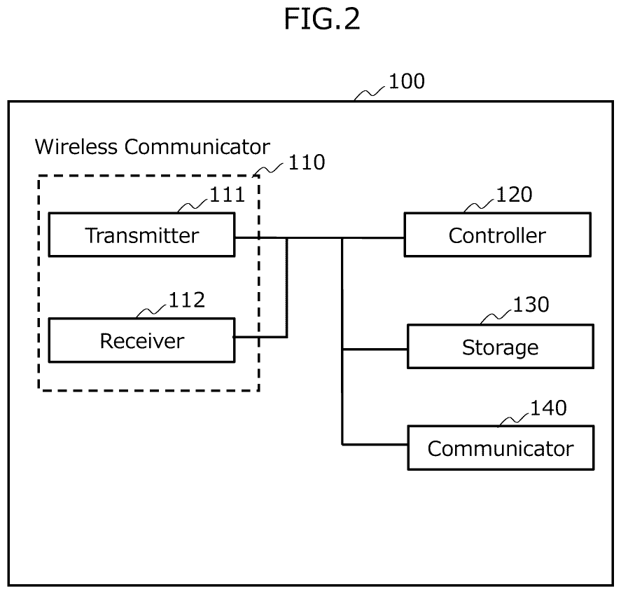

Next, the base station 100 will be described. An example of a functional block configuration of the base station 100 is illustrated in FIG. 2. The base station 100 includes a wireless communication unit 110, a controller 120, a storage 130, and a communicator 140.

The wireless communication unit 110 includes a transmitter 111 and a receiver 112, and performs wireless communication with the terminal 200. Specifically, the transmitter 111 transmits, to the terminal 200, downlink signals such as a signal of a random access procedure, a signal of a radio resource control (RRC) layer, a downlink data signal, a downlink control signal, and a downlink reference signal, for example.

Furthermore, the receiver 112 can receive, for example, an uplink signal such as a signal of a random access procedure, a signal of an RRC layer, an uplink data signal, and an uplink control signal transmitted from the terminal 200.

The controller 120 controls the base station 100. Specifically, the controller 120 can control signal processing of a signal received by the receiver 112, creation of a transmission block (TB), mapping of the transmission block to a wireless resource, and the like.

The storage 130 can store, for example, a downlink data signal.

The communicator 140 is connected to a network device (for example, an upper-level device or another base station device) in a wired or wireless manner to perform communication. The data signal directed to the terminal 200 received by the communicator 140 can be stored in the storage 130.

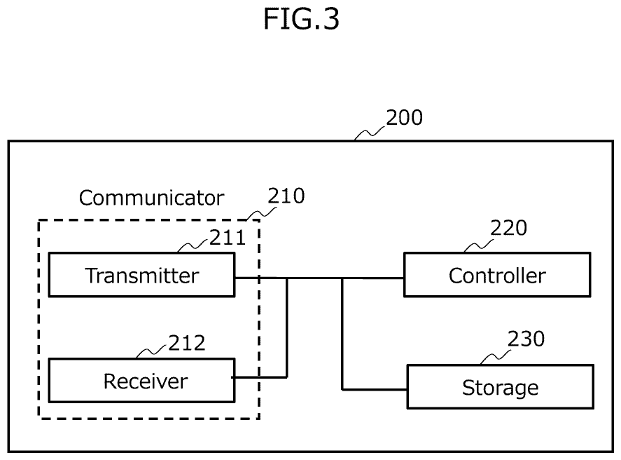

Next, the terminal 200 will be described. FIG. 3 is an example of a functional block configuration diagram of the terminal 200 in the wireless communication system of the first embodiment. As illustrated in FIG. 3, the terminal 200 includes a communicator 210, a controller 220, and a storage 230. These components are connected so that signals and data can be input and output in one direction or in both directions. Note that the communicator 210 can be described separately as a transmitter 211 and a receiver 212.

The transmitter 211 transmits a data signal and a control signal by wireless communication via an antenna. Note that the antenna may be common for transmission and reception. The transmitter 211 transmits, for example, an uplink signal such as a signal of a random access procedure, a signal of an RRC layer, an uplink data signal, an uplink control signal, and uplink reference signal.

The receiver 212 receives a downlink signal such as a signal of a random access procedure, a downlink data signal, and a downlink control signal transmitted from the base station 100, for example. Furthermore, the received signal may include, for example, a reference signal used for channel estimation and demodulation. Furthermore, the receiver 212 may receive a reference signal (for example, sounding reference signal (SRS)) transmitted from another terminal.

The controller 220 controls the terminal 200. Specifically, the controller 220 can control establishment of an RRC connection with the base station 100, signal processing of a signal received by the receiver 212, creation of a transport block (TB), mapping of the transport block to a radio resource, and the like.

The storage 230 can store, for example, an uplink data signal. In addition, the storage 230 can store configuration information (or setting information) related to wireless communication transmitted from the base station 100.

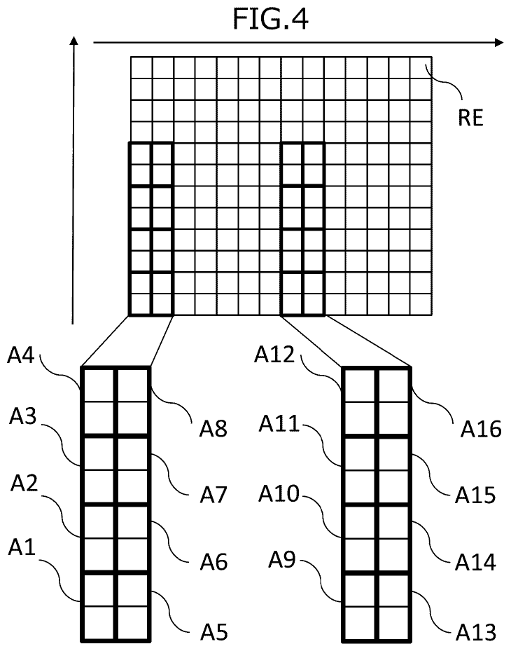

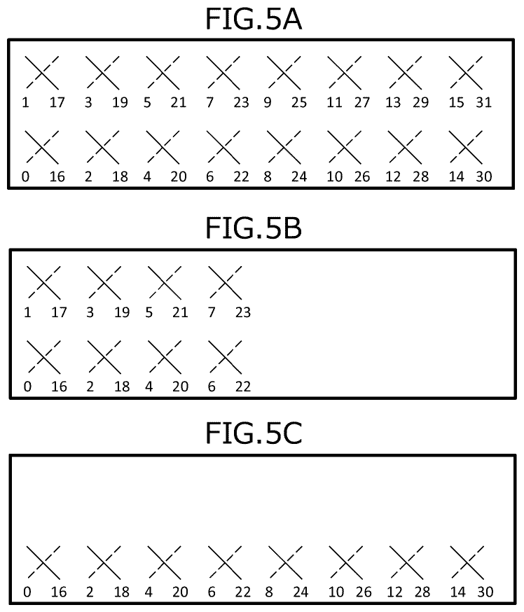

Here, a relationship between a resource block and an antenna port will be described. FIG. 4 is a diagram illustrating an example of a CSI-RS resource in a resource block. In addition, FIGS. 5A to 5C are diagrams illustrating an example of an antenna port pattern. Note that the example illustrated in FIGS. 5A to 5C is an example, and it is not limited thereto. Note that FIG. 5A is an example illustrating 32 antenna ports. FIG. 5B is a first example when 32 antenna ports among 16 antenna ports are used. FIG. 5C is a second example when 32 antenna ports among 16 antenna ports are used.

The resource block illustrated in FIG. 4 has an area A1 to an area A16. In the resource block of FIG. 4, the horizontal axis represents time, and the vertical axis represents frequency.

The area A1 is an area corresponding to a signal transmitted on the antenna ports 0 and 1. The area A2 is an area corresponding to a signal transmitted on the antenna ports 2 and 3. The area A3 is an area corresponding to a signal transmitted on the antenna ports 4 and 5. The area A4 is an area corresponding to a signal transmitted on the antenna ports 6 and 7. The area A5 is an area corresponding to a signal transmitted on the antenna ports 8 and 9. The area A6 is an area corresponding to a signal transmitted on the antenna ports 10 and 11. The area A7 is an area corresponding to a signal transmitted on the antenna ports 12 and 13. The area A8 is an area corresponding to a signal transmitted on the antenna ports 14 and 15. The area A9 is an area corresponding to a signal transmitted on the antenna ports 16 and 17. The area A10 is an area corresponding to a signal transmitted on the antenna ports 18 and 19. The area A11 is an area corresponding to a signal transmitted on the antenna ports 20 and 21. The area A12 is an area corresponding to a signal transmitted on the antenna ports 22 and 23. The area A13 is an area corresponding to a signal transmitted on the antenna ports 24 and 25. The area A14 is an area corresponding to a signal transmitted on the antenna ports 26 and 27. The area A15 is an area corresponding to a signal transmitted on the antenna ports 28 and 29. The area A16 is an area corresponding to a signal transmitted on the antenna ports 30 and 31. Note that the resource block illustrated in FIG. 4 includes 12×14=168 resource elements (REs).

A relationship between FIG. 4 and FIGS. 5A to 5C will be described.

In the pattern of the antenna ports illustrated in FIG. 5A (hereinafter, the pattern is referred to as a first pattern), signals are transmitted using two antenna ports in each of the areas A1 to A16 illustrated in FIG. 4. For example, in the area A1, signals are transmitted on the antenna ports 0 and 1. In short, FIG. 5A transmits a signal by using 32 antenna ports.

In the pattern of the antenna ports illustrated in FIG. 5B (hereinafter, the pattern is referred to as a second pattern), signals are transmitted using two antenna ports in each of the areas A1 to A4 and the areas A9 to A12 illustrated in FIG. 4. For example, in the area A1, signals are transmitted on the antenna ports 0 and 1, and no signal is transmitted in the area A5.

In the pattern of the antenna ports illustrated in FIG. 5C (hereinafter, the pattern is referred to as a third pattern), signals are transmitted using one antenna port in each of the areas A1 to A16 illustrated in FIG. 4. For example, in the area A1, signals are transmitted on the antenna port 0.

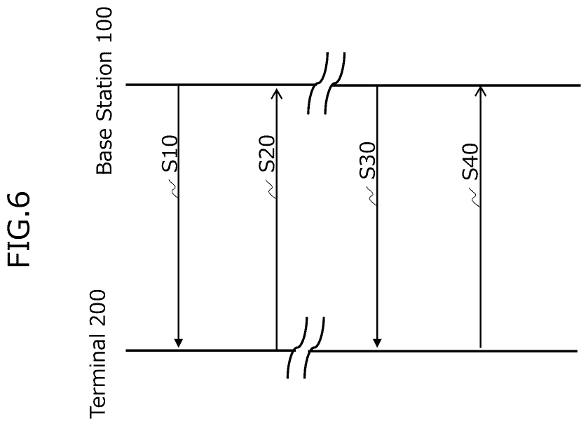

Next, processing in the first embodiment will be described with reference to FIG. 6. FIG. 6 is a diagram illustrating an example of a sequence of the wireless communication system in the first embodiment.

The transmitter 111 of the base station 100 transmits the first signal including the information related to the transmission power of the base station 100 to the terminal 200 (step S10). Note that the first signal is, for example, a signal of a radio resource control (RRC) layer. In addition, the signal of the RRC layer includes, for example, an RRC Reconfiguration Message and an RRC Setup message. Note that the information related to the transmission power of the base station 100 is, for example, information on a power offset corresponding to each pattern with respect to an NZP CSI-RS resource element (RE) or an secondary synchronization signal (SSS) resource element (RE). For example, the information related to the transmission power is information on an offset value of a PDSCH energy per resource element (EPRE) with respect to the EPRE of a CSI-RS serving as a reference, information on an offset value of a PDSCH EPRE corresponding to each EPRE of the CSI-RS of each pattern, or information on an offset value of an EPRE of the CSI-RS with respect to an EPRE of a synchronization signal (for example, the secondary synchronization signal). Furthermore, the information related to the transmission power may be, for example, information related to an EPRE of a synchronization signal (for example, the secondary synchronization signal). Note that the relationship between the information related to the transmission power and the measurement information of the terminal 200 will be described later. In addition, the first signal includes configuration information reporting one piece of measurement information or one piece of reference signal resource configuration information including a plurality of pieces of sub-configuration information for each antenna port pattern. The sub-configuration information may be described as a sub-configuration for measurement.

After the receiver 212 receives the first signal including the information on the transmission power of the base station 100, the transmitter 211 of the terminal 200 transmits a response signal to the received first signal to the base station 100 (step S20). Note that the response signal is, for example, a signal for notifying a result of processing on the information included in the first signal. For example, the response signal is an RRC Reconfiguration Complete Message or an RRC Setup Complete message.

The base station 100 transmits a second signal to be measured by the terminal 200 (step S30). The second signal is, for example, a reference signal or a synchronization signal (for example, the secondary synchronization signal). For example, the second signal is transmitted in the areas A1 to A16 of the resource block described in FIG. 4 by using the antenna ports corresponding to the areas A1 to A16.

The receiver 212 of the terminal 200 receives the second signal and measures the reception power (step S30). Then, the terminal 200 transmits information corresponding to the measurement result to the base station 100 (step S40). The reception power is an example of the measurement information. Further, the reception power may be, for example, EPRE. Note that the information corresponding to the measurement result is, for example, the measurement information measured in step S30, a value obtained from the measurement information, and information corresponding to a value obtained from the measurement information (for example, an index value (for example, the CQI index)).

Here, processing from measurement of reception power to transmission of measurement information in the terminal 200 will be described.

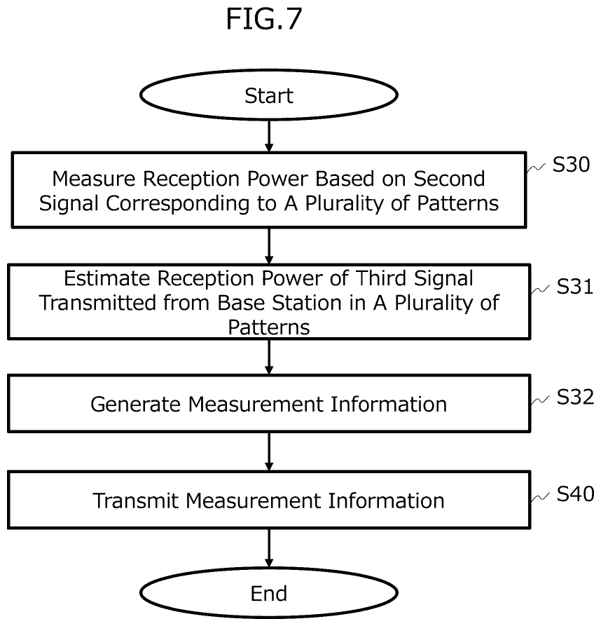

FIG. 7 is a diagram illustrating an example of a processing flow of the terminal 200 according to the first embodiment. Note that the same processing portions as those in FIG. 6 are denoted by the same reference numerals.

The receiver 212 of the terminal 200 receives the second signal transmitted from the base station 100, and measures the received reception power corresponding to the plurality of patterns based on the second signal (step S30). The reception power to be measured is, for example, the EPRE of the second signal.

The controller 220 of the terminal 200 estimates the reception power of the third signal transmitted by the base station 100 from the reception power measured in step S30 (step S31).

The controller 220 of the terminal 200 generates measurement information according to the estimated reception power of the third signal (step S32). Then, the transmitter 211 of the terminal 200 transmits the measurement information to the base station 100 (step S40).

A relationship between the information related to the transmission power and the measurement information of the terminal 200 will be described.

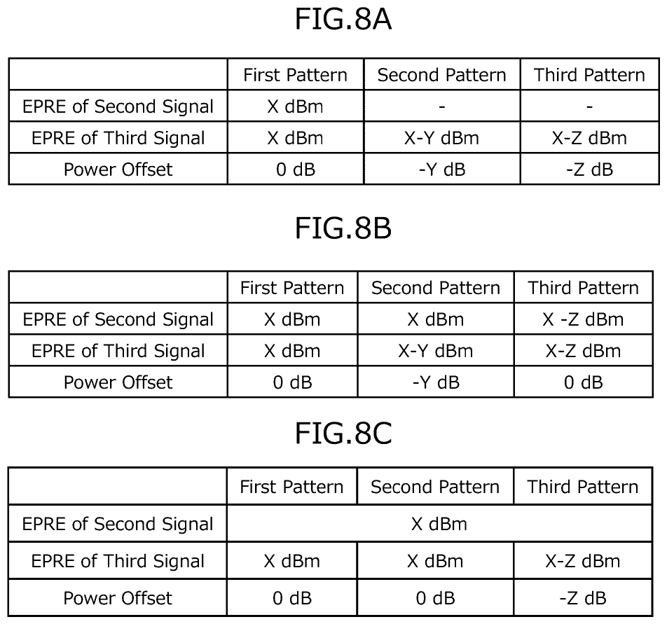

FIGS. 8A to 8C are diagrams illustrating an example of a relationship among an EPRE of a second signal received by the terminal 200, an EPRE of a third signal received by the terminal 200, and information related to transmission power. The pattern 1 in FIGS. 8A to 8C corresponds to the first pattern illustrated in FIG. 5A, the pattern 2 in FIGS. 8A to 8C corresponds to the second pattern illustrated in FIG. 5B, and the pattern 3 in FIGS. 8A to 8C corresponds to the third pattern illustrated in FIG. 5C. In addition, the measurement information will be described as an EPRE, but is not limited thereto. Note that the EPRE of the third signal received by the terminal 200 means, for example, that the terminal 200 estimates the EPRE of the third signal.

FIG. 8A is a diagram illustrating a relationship between the EPRE of the third signal and the power offset with reference to the EPRE of the second signal measured in the first pattern. Note that, in FIG. 8A, the second signal is, for example, the CSI-RS, and the third signal is, for example, a PDSCH.

After measuring the EPRE of the second signal in step S30 of FIG. 7, the controller 220 of the terminal 200 estimates the EPRE of the third signal of each of the first pattern, the second pattern, and the third pattern using the information on the power offset in step S31 of FIG. 7.

Specifically, the controller 220 of the terminal 200 calculates the EPRE of the third signal in the first pattern as XdBm according to XdBm that is the value of the EPRE of the second signal serving as a reference and the value (0 dB) of the information on the power offset. Similarly, EPRE of the third signal in the second pattern is calculated as X-YdBm according to XdBm that is the value of EPRE of the second signal serving as a reference and the value (−YdB) of the power offset information. In addition, EPRE of the third signal in the third pattern is calculated as X-ZdBm according to XdBm that is the value of EPRE of the second signal serving as a reference and the value (−ZdB) of the power offset information. For example, Y and Z are 3. Further, the EPRE of the second signal is an example of the first EPRE, and the EPRE of the third signal is an example of the second EPRE. In addition, the value of the information of the power offset is an example of information indicating a difference between the EPRE of the second signal and the EPRE of the third signal.

The information on the power offset of each pattern is determined according to the information on the transmission power included in the first signal. Specifically, a value (0 dB in the case of FIG. 8A) of the power offset corresponding to the configuration information configuring the first pattern or the configuration identifier is set. Similarly, a value (−YdB in the case of FIG. 8A) of the power offset corresponding to the configuration information configuring the second pattern or the configuration identifier is set. In addition, a value (−ZdB in the case of FIG. 8A) of the power offset corresponding to the configuration information configuring the third pattern or the configuration identifier is set. Each of the configuration information configuring the first pattern, the configuration information configuring the second pattern, and the configuration information configuring the third pattern corresponds to one of the plurality of pieces of sub configuration information.

FIG. 8B is a diagram illustrating a relationship between an EPRE of the third signal corresponding to each antenna port pattern and the power offset with respect to an EPRE of the second signal measured in each antenna port pattern. Note that, in FIG. 8B, the second signal is, for example, the CSI-RS, and the third signal is, for example, a PDSCH.

After measuring the EPRE of the second signal of each pattern in step S30 of FIG. 7, the controller 220 of the terminal 200 estimates the EPRE of the third signal of each of the first pattern, the second pattern, and the third pattern using the information of the power offset in step S31 of FIG. 7.

Specifically, the controller 220 of the terminal 200 calculates the EPRE of the third signal in the first pattern as XdBm according to XdBm that is the value of the EPRE of the second signal of the first pattern and the value (0 dB) of the information on the power offset. Similarly, EPRE of the third signal in the second pattern is calculated as X-YdBm according to XdBm that is the value of EPRE of the second signal of the second pattern and the value (−YdB) of the power offset information. In addition, EPRE of the third signal in the third pattern is calculated as X-ZdBm according to X-ZdBm that is the value of EPRE of the second signal of the third pattern and the value (0 dB) of the power offset information.

The information on the power offset of each pattern is determined according to the information on the transmission power included in the first signal. Specifically, a value (0 dB in the case of FIG. 8B) of the power offset corresponding to the configuration information configuring the first pattern or the configuration identifier is set. Similarly, a value (−YdB in the case of FIG. 8B) of the power offset corresponding to the configuration information configuring the second pattern or the configuration identifier is set. In addition, a value (0 dB in the case of FIG. 8B) of the power offset corresponding to the configuration information configuring the third pattern or the configuration identifier is set. Each of the configuration information configuring the first pattern, the configuration information configuring the second pattern, and the configuration information configuring the third pattern corresponds to one of the plurality of pieces of sub configuration information.

FIG. 8C is a diagram illustrating a relationship between an EPRE of the third signal corresponding to each antenna port pattern and the power offset with respect to an EPRE of the second signal. In FIG. 8C, the second signal is, for example, a synchronization signal (for example, the secondary synchronization signal), and the third signal is, for example, the CSI-RS.

After measuring the EPRE of the second signal in step S30 of FIG. 7, the controller 220 of the terminal 200 estimates the EPRE of the third signal of each of the first pattern, the second pattern, and the third pattern using the information on the power offset in step S31 of FIG. 7.

Specifically, the controller 220 of the terminal 200 calculates the EPRE of the third signal in the first pattern as XdBm according to XdBm that is the value of the EPRE of the second signal and the value (0 dB) of the information on the power offset. Similarly, EPRE of the third signal in the second pattern is calculated as XdBm according to XdBm that is the value of EPRE of the second signal and the value (0 dB) of the information on the power offset. In addition, EPRE of the third signal in the third pattern is calculated as X-ZdBm according to XdBm that is the value of EPRE of the second signal and the value (−ZdB) of the information on the power offset.

The information on the power offset of each pattern is determined according to the information on the transmission power included in the first signal. Specifically, a value (0 dB in the case of FIG. 8C) of the power offset corresponding to the configuration information configuring the first pattern or the configuration identifier is set. Similarly, a value (0 dB in the case of FIG. 8C) of the power offset corresponding to the configuration information configuring the second pattern or the configuration identifier is set. In addition, a value (−ZdB in the case of FIG. 8C) of the power offset corresponding to the configuration information configuring the third pattern or the configuration identifier is set. Each of the configuration information configuring the first pattern, the configuration information configuring the second pattern, and the configuration information configuring the third pattern corresponds to one of the plurality of pieces of sub configuration information.

Note that the plurality of pieces of sub-configuration information may correspond to, for example, information indicating an antenna port subset and information on the power offset. For example, the information indicating the antenna port subset is information in a bitmap format corresponding to the antenna port. Note that the information in the bitmap format may be the same number of bits as the number of antenna ports, or may be a number of bits obtained by dividing the number of antenna ports by a predetermined number, with antenna ports being grouped in the predetermined number. For example, in a case where the information in the bitmap format is 8 bits, “11111111” indicates the first pattern, “11110000” indicates the second pattern, and “10101010” indicates the third pattern.

Then, an offset corresponding to the antenna port pattern may be notified by information indicating an antenna port subset corresponding to the same sub-configuration information and information on a power offset corresponding to the same sub-configuration information.

In a case where the power offset for the measurement resource is set in the configuration information (for example, CSI-RS Resource Configuration) reporting one piece of measurement information and the power offset for each antenna port is set in the sub-configuration information, the power offset for the measurement resource may be ignored and the power offset included in the sub-configuration information may be adapted in the configuration information (for example, CSI-RS Resource Configuration) reporting one piece of measurement information. Alternatively, in the configuration information (for example, CSI-RS Resource Configuration) for reporting one piece of measurement information, a value obtained by summing the power offset with respect to the measurement resource and the power offset or the parameter related to the power offset included in the sub-configuration information may be used as the value of the power offset.

The configuration information (for example, CSI-RS Resource Configuration) reporting one piece of measurement information may include a plurality of power offsets and an identifier for each of the plurality of power offsets, and the corresponding identifier may be included as the information on the power offset included in the sub configuration information.

As described above, in the first embodiment, in a case where the configuration information reporting one piece of measurement information or one piece of reference signal resource configuration information includes a plurality of pieces of sub-configuration information for each pattern of the antenna ports, the information on the power offset for estimating the third signal is included for each pattern of the antenna ports, so that the EPRE can be estimated for each pattern of the antenna ports. Therefore, the state of the signal transmitted from the base station according to the setting of the antenna port is estimated.

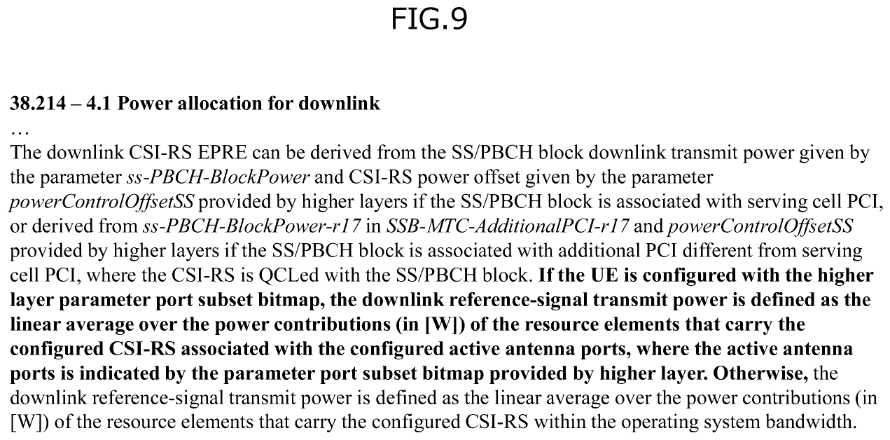

Note that the first embodiment may be reflected in the specification as illustrated in FIG. 9, for example. FIG. 9 is a diagram illustrating an example in which the processing of the example of the first embodiment is reflected in the specification (TS38.214). Note that FIG. 9 illustrates an example of description regarding transmission power of the CSI-RS when information in a bitmap format is provided as information indicating an antenna port subset.

### SECOND EMBODIMENT

In the first embodiment, an example has been described in which the base station 100 transmits the information on the power offset for each pattern of the antenna ports to the terminal 200 as information t related to the transmission power. In a second embodiment, an example will be described in which the information on the reception power of the third signal is calculated using the parameter related to the antenna port for each pattern of the antenna port. In the second embodiment, the wireless communication system, the base station, and the terminal are the same as those in the first embodiment, and thus the description thereof will be omitted. In addition, in the second embodiment, description of parts similar to those in the first embodiment will be omitted.

In the second embodiment, the information related to the transmission power is the information related to the antenna port pattern.

In short, in the second embodiment, the first signal transmitted in step S10 in FIG. 6 includes the information on the pattern of the antenna port as the information related to the transmission power.

The controller 220 of the terminal 200 calculates a ratio between the EPRE of the second signal and the EPRE of the third signal from the information related to the pattern of the antenna port included in each of the plurality of pieces of sub-configuration information. Note that the information related to the antenna port pattern is, for example, information in a bitmap format.

Specifically, the power offset (PO) is calculated from the information on the power offset corresponding to one piece of reference signal resource configuration information (Power control offset) and the information on the pattern of the antenna port (Number of active antenna ports, Number of total antenna ports) using Equation (1) below.

$$PO = 10 {log}_{10} \frac{Number of active antenna ports}{Number of total antenna ports} + Power control offset$$

Note that Number of active antenna ports indicates the number of active antenna ports, and Number of total antenna ports indicates the total number of antenna ports. For example, in the case of the first pattern, the Number of active antenna ports is 32, and the Number of total antenna ports is 32. In addition, for example, in the case of the second pattern, the Number of active antenna ports is 16, and the Number of total antenna ports is 32. In addition, for example, in the case of the third pattern, the Number of active antenna ports is 16, and the Number of total antenna ports is 32.

As described above, in the second embodiment, in a case where the configuration information reporting one piece of measurement information or one piece of reference signal resource configuration information includes a plurality of pieces of sub-configuration information for each pattern of the antenna ports, the EPRE of the third signal can be estimated for each pattern of the antenna ports by estimating, for each pattern of the antenna ports, a power offset for estimating the third signal according to the ratio between the number of active antenna ports and the total number of antenna ports. Therefore, the state of the signal transmitted from the base station according to the setting of the antenna port is estimated.

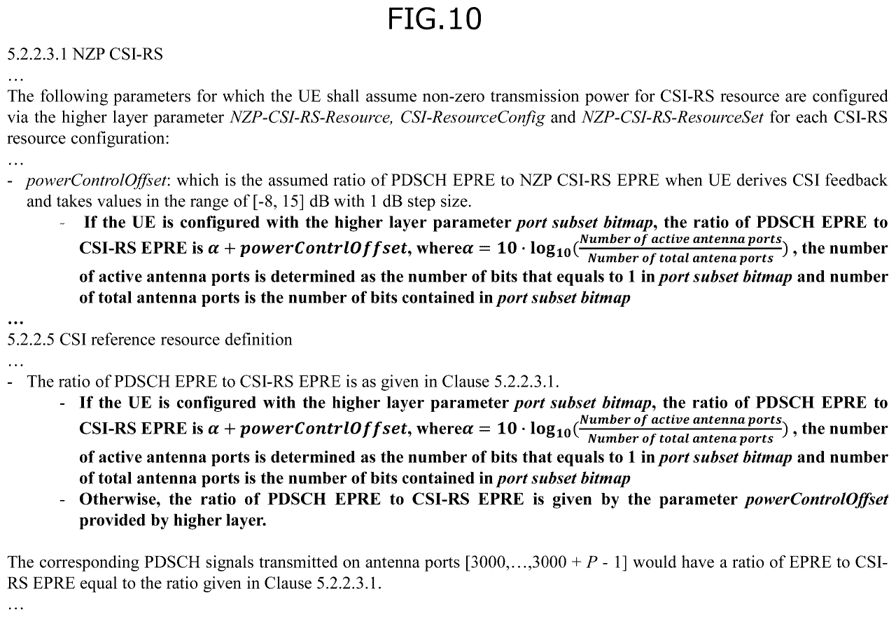

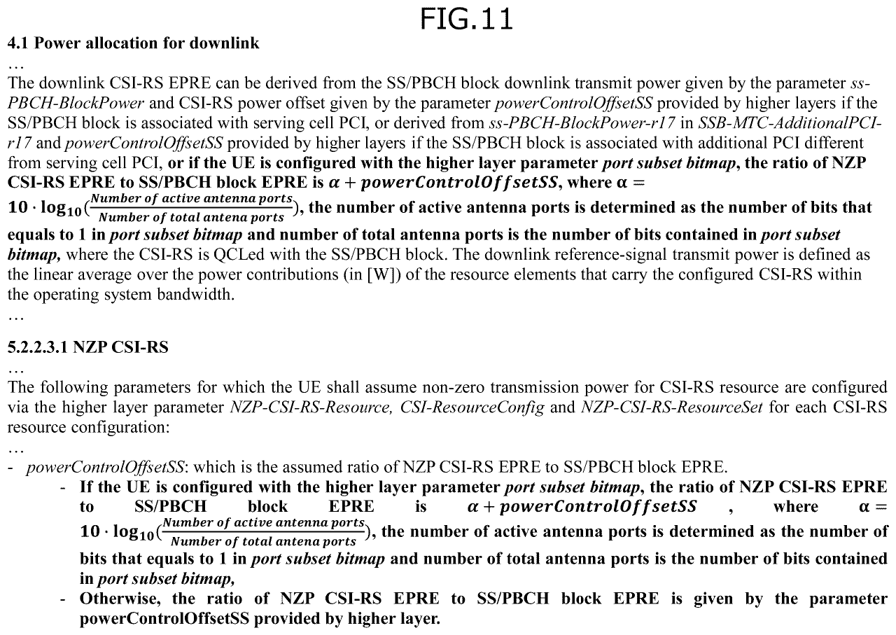

Note that the second embodiment may be reflected in the specification as illustrated in FIGS. 10 and 11, for example. FIG. 10 is a diagram illustrating a first example in which the processing of the example of the second embodiment is reflected in the specification (TS38.214). Note that FIG. 10 illustrates an example in a case where the second signal is the CSI-RS and the third signal is a PDSCH.

In addition, FIG. 11 is a diagram illustrating a second example in which the processing of the example of the second embodiment is reflected in the specification (TS38.214). Note that FIG. 11 illustrates an example in a case where the second signal is an SS/PBCH block and the third signal is the CSI-RS. Note that the SS/PBCH block corresponds to, for example, a synchronization signal.

In addition, the second embodiment may be reflected in the specification as illustrated in FIG. 9, for example.

As described above, in the second embodiment, the EPRE of the third signal can be estimated by using the information about the antenna port pattern received by the terminal 200. Therefore, the state of the signal transmitted from the base station according to the setting of the antenna port is estimated.

Note that the second embodiment can be appropriately combined with the first embodiment within a range not contradictory.

### HARDWARE CONFIGURATION OF EACH DEVICE IN EACH EMBODIMENT

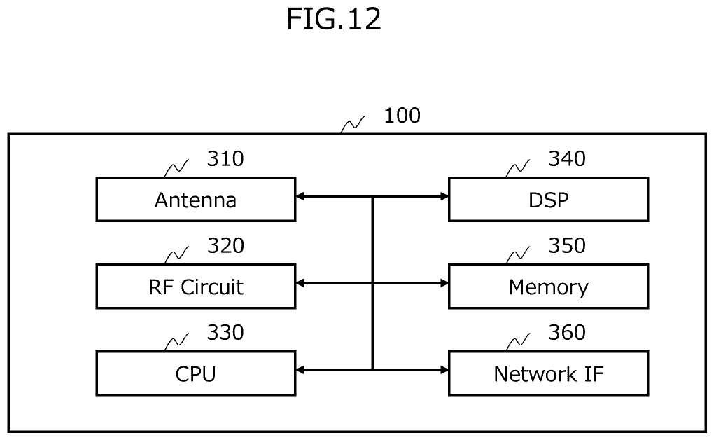

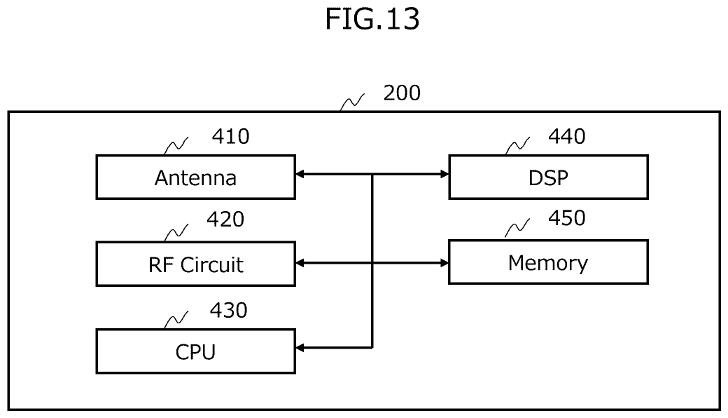

A hardware configuration of each device in the wireless communication system of each embodiment will be described with reference to FIGS. 12 to 13.

FIG. 12 is a diagram illustrating an example of a hardware configuration of the base station 100. As illustrated in FIG. 12, the base station 100 includes, for example, a radio frequency (RF) circuit 320 including an antenna 310, a central processing unit (CPU) 330, a digital signal processor (DSP) 340, a memory 350, and a network interface (IF) 360 as hardware components. The CPU is connected via a bus so as to be able to input and output various signals and data signals. A memory 450 includes, for example, at least one of a random access memory (RAM) such as a synchronous dynamic random access memory (SDRAM), a read only memory (ROM), and a flash memory, and stores a program, control information, and a data signal.

The correspondence between the functional configuration of the base station 100 illustrated in FIG. 2 and the hardware configuration of the base station 100 illustrated in FIG. 12 will be described. The transmitter 111 and the receiver 112 (or the wireless communication unit 110) are realized by, for example, the RF circuit 320, or the antenna 310 and the RF circuit 320. The controller 120 is realized by, for example, the CPU 330, the DSP 340, the memory 350, a digital electronic circuit (not illustrated), and the like. Examples of the digital electronic circuit include an Application Specific Integrated Circuit (ASIC), a Field Programmable Gate Array (FPGA), and a Large Scale Integration (LSI). Furthermore, the communicator 140 is realized by, for example, the RF circuit 320, the antenna 310, and the RF circuit 320, or the network Interface (IF) 360. For example, the control of the base station 100 of the first and second embodiments is realized by executing a control program stored in the memory 350.

Note that, in the base station 100, a plurality of data signals transmitted in a plurality of sub-bands can be generated, but a filter for generating the data signals may be configured independently for each sub-band.

FIG. 13 is a diagram illustrating an example of a hardware configuration of the terminal 200. As illustrated in FIG. 13, the terminal 200 includes, for example, an RF circuit 420 including an antenna 410, a CPU 430, and a memory 450 as hardware components. Furthermore, the terminal 200 may include a display device such as a liquid crystal display (LCD) connected to the CPU 430 or DSP 440. The memory 450 includes, for example, at least one of a RAM such as an SDRAM, a ROM, and a flash memory, and stores a program, control information, and a data signal.

The correspondence between the functional configuration of the terminal 200 illustrated in FIG. 3 and the hardware configuration of the terminal 200 illustrated in FIG. 13 will be described. The transmitter 211 and the receiver 212 (or the communicator 210) are realized by, for example, the RF circuit 420, or the antenna 410 and the RF circuit 420. The controller 220 is realized by, for example, the CPU 430, the memory 450, a digital electronic circuit (not illustrated), and the like. Examples of the digital electronic circuit include an ASIC, an FPGA, and an LSI. For example, the control of the terminal 200 of the first and second embodiments is realized by executing a control program stored in the memory 450.

Note that, in each embodiment, an example of the base station and, the terminal has been described, but the disclosed technology is not limited thereto, and can be applied to various devices such as electronic devices mounted on automobiles, trains, airplanes, artificial satellites, and the like, electronic devices carried by drones and the like, robots, AV devices, household appliances, office devices, vending machines, and other household appliances.

In each embodiment, the fifth generation mobile communication has been described as an example. However, the disclosed technology is not limited to these. For example, the disclosed technology may be applied to mobile communication of different generations such as a sixth generation and a seventh generation.

A terminal device can estimate transmission power of a base station according to setting of an antenna port.

Throughout the descriptions, the indefinite article “a” or “an”, or adjective “one” does not exclude a plurality.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A terminal comprising:
a receiver configured to receive third information related to transmission power and fourth information related to transmission power;
a controller configured to generate measurement information for each of a plurality of sub-configurations for measurement in accordance with the third information and the fourth information; and
a transmitter configured to transmit the measurement information, wherein
the controller estimates second information related to reception power of a third signal corresponding to each of the plurality of sub-configurations for measurement according to first information related to reception power of a second signal received by the receiver, the third information, and the fourth information, and generates the measurement information.

2. The terminal according to claim 1, wherein
the first information is a first EPRE (energy per resource element) of the second signal,
the second information is a second EPRE of the third signal,
the third information is information indicating a difference between the first EPRE and the second EPRE being set in a CSI-RS (Channel state information-reference signal) Resource Configuration, and
the fourth information is information indicating an additional difference between the first EPRE and the second EPRE being set in the sub-configuration for measurement.

3. The terminal according to claim 2, wherein the second signal is a CSI-RS, and the third signal is a PDSCH (physical downlink shared channel).

4. The terminal according to claim 2, wherein the second signal is a synchronization signal, and the third signal is a CSI-RS.

5. The terminal according to claim 1, wherein the first information is a first EPRE of the second signal, the second information is a second EPRE of the third signal, and the information related to the transmission power is information indicating an antenna port pattern of each of the plurality of sub-configurations for measurement.

6. The terminal according to claim 5, wherein the controller converts, into dB, a ratio between the number of active antenna ports according to the first information and the information indicating the antenna port pattern, and a total number of antenna ports, and estimates the second EPRE.

7. The terminal according to claim 1, wherein
the receiver receives a first signal including the third information, the fourth information, and information on antenna port patterns corresponding to each of the plurality of sub-configuration for measurements,
the information related to transmission power is composed of information on a plurality of power offsets, and
each piece of the information on the plurality of power offsets is included in the corresponding one of the plurality of sub-configurations for measurement.

8. A base station comprising:
a transmitter configured to transmit third information related to transmission power and fourth information related to transmission power; and
a receiver configured to receive measurement information for each of a plurality of sub-configurations for measurement, the measurement information being generated by estimating second information related to reception power of a third signal corresponding to each of the plurality of sub-configurations for measurement according to first information related to reception power of a second signal, the second information, and the third information.

9. A communication system comprising:
a base station configured to transmit third information related to transmission power and fourth information related to transmission power; and
a terminal configured to generate measurement information for each of a plurality of sub-configurations for measurement in accordance with the third information and the fourth information, and to transmit the measurement information, wherein
the terminal estimates second information related to reception power of a third signal corresponding to each of the plurality of sub-configurations for measurement according to first information related to reception power of a second signal, the third information, and the fourth information, and generates the measurement information.
